(19) United States
(12) Patent Application Publication
(10) Pub. No.: US 2016/0370237 A1
(43) Pub. Date: Dec. 22, 2016

(54) PRESSURE SENSOR

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventor: Renbin ZHU, Beijing (CN)

(21) Appl. No.: 14/905,845

(22) PCT Filed: Jun. 26, 2015
(86) PCT No.: PCT/CN2015/082493

§ 371 Date: Jan. 18, 2016

(30) Foreign Application Priority Data
Jan. 23, 2015 (CN) 201510036004.X

(51) Int. Cl. G01L 1/08; G01G 1/18; G01L 1/24

(52) U.S. Cl. CPC G01L 1/08; G01L 1/24; G01G 1/18

(57) ABSTRACT

A pressure sensor includes a lever having a first end and a second end and being rotatable around a fulcrum; a pressure receiving member connected to the first end of the lever and configured to drive the first end of the lever to move when receiving a pressure; and a first displacement sensing assembly and a second displacement sensing assembly, the first displacement sensing assembly being connected to the second end of the lever and being configured to be capable of cooperating with the second displacement sensing assembly to detect a displacement of the second end of the lever.

### CROSS-REFERENCE TO RELATED APPLICATION

This application is a Section 371 National Stage Application of International Application No. PCT/CN2015/082493, filed on 26 Jun. 2015, entitled “PRESSURE SENSOR”, which has not yet been published, which claims priority to Chinese Application No. 201510036004.X, filed on 23 Jan. 2015, incorporated herein by reference in their entirety.

### BACKGROUND

1. Technical Field

Embodiments of the present invention relates to a pressure sensor.

2. Description of the Related Art

Pressure sensors are generally applied in various conveying apparatus. In these conveying apparatus, the pressure sensor is used to judge whether or not there is an object by sensing a pressure at a particular position, and/or whether or not an object is moved on the conveying apparatus by sensing a change in pressure, and so on.

### SUMMARY

Embodiments of the present invention provides a pressure sensor. The pressure sensor comprises: a lever having a first end and a second end and being rotatable around a fulcrum; a pressure receiving member connected to the first end of the lever and configured to drive the first end of the lever to move when receiving a pressure; and a first displacement sensing assembly and a second displacement sensing assembly, the first displacement sensing assembly being connected to the second end of the lever and being configured to be capable of cooperating with the second displacement sensing assembly to detect a displacement of the second end of the lever.

### BRIEF DESCRIPTION OF THE DRAWINGS

In order to explain technical solutions of the embodiments of the present invention more clearly, the embodiments of the present invention will now be described by means of examples with reference to the accompanying drawings.

FIG. 1 is a schematic structural diagram which shows a pressure sensor according to an embodiment of the present invention and in which a light barrier is in a first position;

FIG. 2 is another schematic structural diagram which shows the pressure sensor according to the embodiment of the present invention and in which the light barrier is in a second position; and

FIGS. 3 and 4 are schematic structural diagrams which show an optical sensor for the pressure sensor according to the embodiment of the present invention and its operational principle, and in FIG. 3, the light barrier is in the first position, while in FIG. 4, the light barrier is in the second position.

### DETAILED DESCRIPTION OF THE EMBODIMENTS

A further description of the invention will be made in detail as below with reference to embodiments of the present invention taken in conjunction with the accompanying drawings. The following embodiments are intended to explain the present invention and the present invention should not be construed as being limited to the embodiment set forth herein.

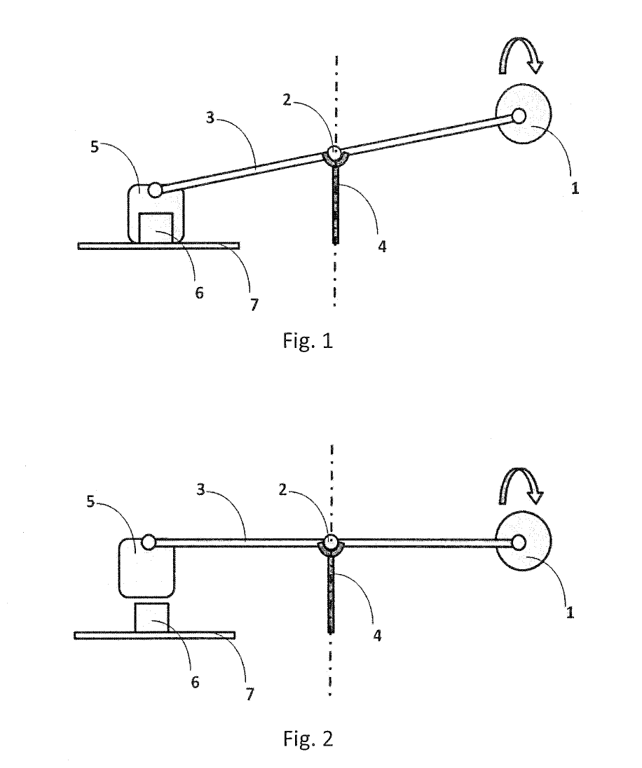

FIG. 1 is a schematic structural diagram which shows a pressure sensor according to embodiments of the present invention. As shown in FIG. 1, the pressure sensor comprises: a lever 3 having a first end and a second end and being rotatable around a fulcrum; a pressure receiving member connected to the first end of the lever 3 and configured to drive the first end of the lever 3 to move when receiving a pressure; and a first displacement sensing assembly and a second displacement sensing assembly, the first displacement sensing assembly being connected to the second end of the lever 3 opposite to the first end and being configured to be capable of cooperating with the second displacement sensing assembly to detect a displacement of the second end of the lever 3. The first displacement sensing assembly and the second displacement sensing assembly may both comprise optical displacement sensing assemblies. Since no consumable component such as a spring is used in the pressure sensor, its service life can be elongated.

In an specific embodiment, the pressure receiving member may comprise a roller 1 or a smooth body, and the pressure receiving member may be configured such that the pressure receiving member receives a pressure applied by an object when the object is moved onto the pressure receiving member, and the applied pressure is released when the object is moved away from the pressure receiving member.

In the embodiment shown in FIG. 1, the pressure receiving member comprises the roller 1. As shown in FIG. 1, the roller 1 is rotatable around a supporting shaft or pivot disposed at the second end of the lever 3 so as to facilitate movement of an object from an outside onto the roller 1 to apply a pressure to the roller 1.

FIG. 2 is another schematic structural diagram which shows the pressure sensor according to the embodiments of the present invention. FIG. 2 is similar to FIG. 1 except that positions of the components are changed. As shown in FIG. 2, when an object (not shown) acts on the roller 1, it presses the roller 1 to move downwards so that a light barrier 5 at the other end of the lever 3 will move upwards.

Although the pressure receiving member shown in the figures is the roller 1, it can be appreciated by those skilled in the art that the pressure receiving member may also be any other appropriate members. For example, the pressure receiving member may also be a member having a smooth surface (i.e., a surface with a low coefficient of friction), such as a smooth sphere, so that an object can conveniently slide onto the spherical pressure receiving member to apply a pressure to the pressure receiving member.

With the pressure receiving member of the abovementioned structure, the object can conveniently move onto and away from the pressure receiving member.

According to embodiments of the present invention, as shown in FIGS. 1 and 2, the pressure sensor is configured such that the first end of the lever 3 is higher than the second end of the lever when no pressure is received by the pressure receiving member; weights of the pressure receiving member and the first displacement sensing assembly are set such that a moment by which the first end of the lever 3 moves downwards around the fulcrum is less than a moment by which the second end of the lever 3 moves downwards around the fulcrum when no pressure is received by the pressure receiving member; or the weights of the pressure receiving member and the first displacement sensing assembly are set such that the moment by which the first end of the lever 3 moves downwards around the fulcrum is slightly less than the moment by which the second end of the lever 3 moves downwards around the fulcrum when no pressure is received by the pressure receiving member. In the pressure sensor according to the embodiment of the present invention, the lever or the pressure receiving member is reset by action of gravity. Specifically, as shown in FIGS. 1 and 2, the pressure sensor is configured such that: when no object acts on the pressure receiving member, a moment generated by gravity of the first displacement sensing assembly at a left side of the lever is greater than a moment generated by gravity of the pressure receiving member at a right side of the lever, so that the first displacement sensing assembly is retained in a lower position, while the pressure receiving member is lifted to be ready to receive a pressure, as shown in FIG. 1; and when an object acts on the pressure receiving member, a moment generated by gravity of the object and the pressure receiving member, which are regarded as a whole, at the right side of the lever is greater than the moment generated by the gravity of the first displacement sensing assembly at the left side of the lever, so that the pressure receiving member moves downwards, while the left side of the lever is lifted, as shown in FIG. 2. In this way, since no consumable component such as a spring is used in the pressure sensor according to the embodiments of the present invention, its service life can be elongated.

In order that the pressure sensor is more sensitive to action of gravity of an object, the pressure sensor may be configured such that: when no pressure is applied to the pressure receiving member, the moment generated by the gravity of the first displacement sensing assembly at the left side of the lever is only slightly greater than the moment generated by the gravity of the pressure receiving member at the right side of the lever. This can be achieved by appropriately setting weights of the first displacement sensing assembly and the pressure receiving member respectively located on both sides of the lever, or by adjusting the fulcrum.

A distance by which the pressure receiving member moves downwards or the light barrier as the first displacement sensing assembly moves upwards may be limited and adjusted by any appropriate position limit device or structure such as a stop plate, a stopper, and the like (not shown), which will be no longer expounded here.

According to embodiments of the present invention, an optical sensor assembly is used as the displacement sensing assembly. As shown in FIGS. 1 and 2, one of the optical displacement sensing assemblies comprises a light barrier 5; the other of the optical displacement sensing assemblies comprises an optical sensor; the optical sensor comprises a light emitting part 6a and a light receiving part 6b; and the light barrier 5 is disposed to be movable between a first position where the light barrier 5 blocks light emitted from the light emitting part 6a towards the light receiving part 6b, and a second position where the light barrier 5 does not block the light emitted from the light emitting part 6a towards the light receiving part 6b.

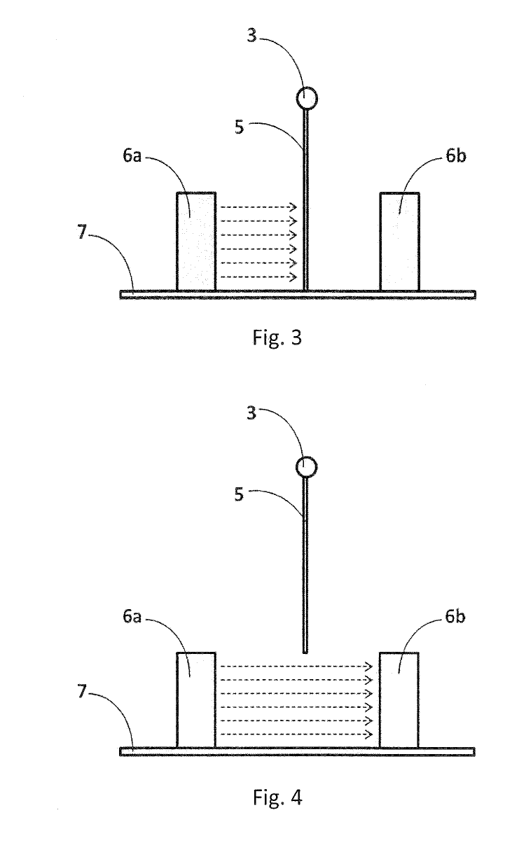

As shown in FIGS. 1 and 2, the optical sensor assembly comprises an optical sensor 6 and the light barrier 5 connected to an end of the lever 3. The optical sensor 6 comprises the light emitting part and the light receiving part (see FIGS. 3 and 4). When the light barrier 5 is positioned between the light emitting part and the light receiving part of the optical sensor 6, the light barrier 5 can block light emitted from the light emitting part so that the light receiving part cannot receive the light emitted from the light emitting part. When the light barrier 5 is removed from between the light emitting part and the light receiving part of the optical sensor 6, the light emitted from the light emitting part is no longer blocked by the light barrier 5 so that the light receiving part can receive the light emitted from the light emitting part. With the optical sensor, a technical problem that conventional pressure sensors have a poor detection accuracy due to use of magnetic sensors is overcome and a high detection accuracy is achieved.

FIGS. 3 and 4 are schematic structural diagrams which show the optical sensor for the pressure sensor according to the embodiments of the present invention and its operational principle. As shown in FIGS. 3 and 4, the optical displacement sensing assembly comprises the optical sensor 6 and the light barrier 5; the optical sensor comprises the light emitting part 6a and the light receiving part 6b; the light barrier 5 is connected to the second end of the lever 3, and the light barrier 5 is disposed to be movable between the first position where the light barrier 5 blocks light emitted from the light emitting part 6a towards the light receiving part 6b, and the second position where the light barrier 5 does not block the light. With the optical sensor of such a specific structure, the optical sensor can more easily cooperate with the pressure sensor and the structure of the pressure sensor is further simplified.

When no pressure is received by the roller 1 from an external object (for example, in this case, there is no object to apply a pressure), the light barrier 5 is in the first position between the light emitting part 6a and the light receiving part 6b of the optical sensor 6. In this case, the light receiving part 6b of the optical sensor 6 cannot receive light emitted from the light emitting part 6a. When the roller 1 receives a pressure from an external object, it is pressed downwards by the pressure so that the roller 1 is displaced downwards. A downward displacement of the roller 1 is converted into an upward displacement of the light barrier 5 by means of the lever 3. In this case, the light barrier 5 is removed upwards from between the light emitting part 6a and the light receiving part 6b of the optical sensor 6 and into the second position, so that the light receiving part 6b of the optical sensor 6 can receive light emitted from the light emitting part 6a. When the light barrier 5 is in the second position, it is indicated that there is an object which applies a pressure to the roller 1. In this case, the light receiving part 6b can send a signal to a control unit or a processor (not shown) of the pressure sensor, so that a subsequent or relevant operation is performed.

Likewise, when the light receiving part 6b does not receive the light emitted from the light emitting part 6a, it may continuously or intermittently send a relevant signal to the control unit or the processor so that a relevant operation and the like are carried out.

As shown in FIGS. 3 and 4, according to embodiments of the present invention, the pressure sensor may further comprise a light barrier supporting platform 7. The light barrier 5 is supported on the light barrier supporting platform 7 when it is in the first position. Specifically, as shown in FIG. 1, when no pressure is received by the roller 1 from an object, the light barrier 5 is placed on the light barrier supporting platform 7 so that the light barrier is appropriately positioned. Likewise, when an object that has acted on the roller 1 is removed, the roller 1 will move upwards so that the light barrier 5 moves downwards. In this case, the light barrier supporting platform 7 can be used to stop downward movement of the light barrier 5 to avoid excessive downward movement of the light barrier 5 to exceed a range of detection of the optical sensor 6 and result in a misdetection. According to another embodiment, the light barrier supporting platform 7 may also be incorporated in the optical sensor assembly. For example, the optical sensor 6 (including the light emitting part 6a and the light receiving part 6b) is also disposed on the light barrier supporting platform 7. By providing the light barrier supporting platform, it is possible to facilitate positioning the light barrier and limiting a position of movement of the light barrier.

According to an aspect of the pressure sensor of the embodiments of the present invention, as shown in FIGS. 1 and 2, the pressure sensor further comprises an adjustable lever supporting stand providing the fulcrum, and a position of the fulcrum in a length direction of the lever can be adjusted by the lever supporting stand. For example, a distance from the fulcrum to the pressure receiving member is remarkably less than, less than, or much less than a distance from the fulcrum to the first displacement sensing assembly. By setting the distance from the fulcrum to the pressure receiving member to be remarkably less than, less than, or much less than the distance from the fulcrum to the displacement sensing assembly, a slight displacement of a pressure receiving member-side end of the lever can be amplified by several times at a displacement sensing assembly-side end of the lever by means of leverage, so that a displacement of such a pressure receiving member-side end of the lever can be accurately detected. Alternatively, the distance from the fulcrum to the pressure receiving member may also be greater than or much greater than the distance from the fulcrum to the first displacement sensing assembly. Specifically, lengths of the lever 3 on both sides of the lever supporting stand can be appropriately set to amplify or reduce the displacement by means of a lever principle. This can be set according to an actual working environment. For example, in some apparatus, a larger or heavier object will cause the pressure receiving member to generate a larger downward displacement, but the optical sensor 6 has a very small volume. In this case, the length of the lever 3 on the optical sensor 6 side may be set to be smaller and the length of the lever 3 on the pressure receiving member side may be set to be greater so that a movement range of the light barrier 5 is reduced. On the other hand, in some apparatus, a smaller or lighter object will cause the pressure receiving member to generate a slight downward displacement, which is difficult to be detected. In this case, the length of the lever 3 on the optical sensor 6 side may be set to be greater and the length of the lever 3 on the pressure receiving member side may be set to be smaller so that the movement range of the light barrier 5 will be amplified by means of leverage, thereby facilitating detection of the movement of the light barrier 5. As a result, a slight displacement of the pressure receiving member which is caused by the object can be detected. In order to achieve the above object, the pressure sensor according to an embodiment of the present invention may be provided with an adjustable lever supporting stand 4. The lever supporting stand 4 may comprise a supporting shaft 2 on which the lever 3 is capable of pivoting. For example, a position of the supporting shaft 2 in a length direction of the lever 3 is adjustable. In an example, this adjustment may be achieved, for example, in such a way that the lever 3 is provided with a plurality of holes (not shown) through which the supporting shaft 2 passes. In another example, the supporting shaft 2 is rotatably disposed on the lever 3 in such a way as to have a fixed position relative to the lever 3, but a position of the supporting shaft 2 relative to the lever supporting stand 4 is adjustable. In this way, the position of the fulcrum in the length direction of the lever can be adjusted according to actual requirements.

According to another aspect of the pressure sensor of the embodiments of the present invention, the pressure sensor may further comprise an isolation member configured to tightly isolate the pressure receiving member and the first and second displacement sensing assemblies from each other within two different spaces. Since the pressure receiving member and the light sensor are respectively located at two different positions through the lever 3, the pressure receiving member and the light sensor may be respectively isolated within the two different spaces in an appropriate manner (such as by means of an isolation member). For example, a corresponding partition and seal may be disposed near the fulcrum provided by the lever supporting stand 4 for the lever 3, so as to tightly isolate the pressure receiving member and the light sensor within the two different spaces, respectively. This is advantageous if it is necessary to apply lubricant, liquid chemicals, and the like to the pressure receiving member since the lubricant and the liquid chemicals cannot enter the space where the optical sensor is located to adversely affect normal operation of the optical sensor, avoiding corrosion of the optical sensor by the liquid chemicals and the like.

The above embodiments are only used to explain the present invention, and should not be construed to limit the present invention. It will be understood by those skilled in the art that various changes and modifications may be made therein without departing from the spirit of the present invention, the scope of which is defined in the appended claims and their equivalents.

1. A pressure sensor comprising:
a lever having a first end and a second end and being rotatable around a fulcrum;
a pressure receiving member connected to the first end of the lever and configured to drive the first end of the lever to move when receiving a pressure; and
a first displacement sensing assembly and a second displacement sensing assembly, the first displacement sensing assembly being connected to the second end of the lever and being configured to be capable of cooperating with the second displacement sensing assembly to detect a displacement of the second end of the lever.

2. The pressure sensor of claim 1, wherein:
the pressure receiving member comprises a roller or a smooth body to enable an object to move onto and away from the pressure receiving member.

3. The pressure sensor of claim 1, wherein:
the first displacement sensing assembly and the second displacement sensing assembly comprise optical displacement sensing assemblies.

4. The pressure sensor of claim 3, wherein:
one of the optical displacement sensing assemblies comprises a light barrier;
the other of the optical displacement sensing assemblies comprises an optical sensor;
the optical sensor comprises a light emitting part and a light receiving part; and
the light barrier is disposed to be movable between a first position where the light barrier blocks light emitted from the light emitting part towards the light receiving part, and a second position where the light barrier does not block the light emitted from the light emitting part towards the light receiving part.

5. The pressure sensor of claim 4, further comprising:
a light barrier supporting platform on which the light barrier is supported when the light barrier is in the first position.

6. The pressure sensor of claim 1, further comprising:
an adjustable lever supporting stand providing the fulcrum, wherein a position of the fulcrum in a length direction of the lever can be adjusted by the lever supporting stand.

7. The pressure sensor of claim 1, wherein:
a distance from the fulcrum to the pressure receiving member is less than a distance from the fulcrum to the first displacement sensing assembly.

8. The pressure sensor of claim 1, further comprising:
an isolation member configured to tightly isolate the pressure receiving member and the first and second displacement sensing assemblies from each other within two different spaces.

9. The pressure sensor of claim 1, wherein:
the pressure sensor is configured such that the first end of the lever is higher than the second end of the lever when no pressure is received by the pressure receiving member.

10. The pressure sensor of claim 1, wherein:
weights of the pressure receiving member and the first displacement sensing assembly are set such that a moment by which the first end of the lever moves downwards around the fulcrum is less than a moment by which the second end of the lever moves downwards around the fulcrum when no pressure is received by the pressure receiving member.

11. The pressure sensor of claim 1, wherein:
weights of the pressure receiving member and the first displacement sensing assembly are set such that a moment by which the first end of the lever moves downwards around the fulcrum is slightly less than a moment by which the second end of the lever moves downwards around the fulcrum when no pressure is received by the pressure receiving member.

12. The pressure sensor of claim 1, wherein:
a distance from the fulcrum to the pressure receiving member is much less than a distance from the fulcrum to the first displacement sensing assembly.

13. The pressure sensor of claim 1, wherein:
the pressure sensor is configured to detect movement of an object.
